(19) United States
(12) Patent Application Publication
(10) Pub. No.: US 2020/0034795 A1
(43) Pub. Date: Jan. 30, 2020

(54) RECOMMENDING RELATED SERVICES

(71) Applicant: Microsoft Technology Licensing, LLC, Redmond, WA (US)

(72) Inventors: Xiang Li, Santa Clara, CA (US); Yida Yao, Gilroy, CA (US); Kuo-Ning Huang, Los Altos, CA (US); Yu Liu, Sunnyvale, CA (US)

(73) Assignee: Microsoft Technology Licensing, LLC, Redmond, WA (US)

(21) Appl. No.: 16/047,333

(22) Filed: Jul. 27, 2018

(51) Int. Cl. G06Q 10/10; G06F 17/30

(52) U.S. Cl. CPC G06Q 10/1053; G06F 17/30867

(57) ABSTRACT

The disclosed embodiments provide a system for recommending related services. During operation, the system determines, using a set of data sources, matching pairs of related services offered through an online system, wherein the set of data sources includes historical interactions with recommended services and historical requests for proposal (RFPs). Next, the system ranks the matching pairs based on the set of data sources and popularities of the matching pairs. The system then identifies, based on the ranking, a set of related services for a service offered through the online system. Finally, the system outputs the set of related services as recommended services to a user of the online system.

### BACKGROUND

### Field

The disclosed embodiments relate to user recommendations. More specifically, the disclosed embodiments relate to techniques for recommending related services.

### Related Art

Online networks may include nodes representing individuals and/or organizations, along with links between pairs of nodes that represent different types and/or levels of social familiarity between the entities represented by the nodes. For example, two nodes in an online network may be connected as friends, acquaintances, family members, classmates, and/or professional contacts. Online networks may further be tracked and/or maintained on web-based networking services, such as online networks that allow the individuals and/or organizations to establish and maintain professional connections, list work and community experience, endorse and/or recommend one another, run advertising and marketing campaigns, promote products and/or services, and/or search and apply for jobs.

In turn, online networks may facilitate activities related to business, sales, recruiting, networking, professional growth, and/or career development. For example, professionals may use an online network to locate prospects, maintain a professional image, establish and maintain relationships, and/or engage with other individuals and organizations. Similarly, recruiters may use the online network to search for candidates for job opportunities and/or open positions. At the same time, job seekers may use the online network to enhance their professional reputations, conduct job searches, reach out to connections for job opportunities, and apply to job listings. Consequently, use of online networks may be increased by improving the data and features that can be accessed through the online networks.

### BRIEF DESCRIPTION OF THE FIGURES

FIG. 1 shows a schematic of a system in accordance with the disclosed embodiments.

FIG. 2 shows a system for recommending related services in an online marketplace in accordance with the disclosed embodiments.

FIG. 3 shows a flowchart illustrating a process of recommending related services in an online marketplace in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The disclosed embodiments provide a method, apparatus, and system for improving use of an online marketplace, which can include an online system of software and/or hardware components that are connected to one another and/or external computer systems via one or more networks. More specifically, the disclosed embodiments provide a method, apparatus, and system for recommending services that relate to other services in which users of the online marketplace have expressed interest. For example, a user may fill out a request for proposal (RFP) for a design service, writing service, accounting service, marketing service, legal service, real estate service, software service, information technology (IT) service, business service, financial service, insurance service, photography service, career service, coaching service, and/or other type of service listed in the online marketplace. After the RFP is submitted, a page confirming successful submission of the RFP may be shown to the user. The page may also include a “related services you may be interested in” module that displays recommendations of services that are related to the service requested by the user in the RFP. The user may click on a recommended service to begin a new RFP for the service; if the user successfully submits the new RFP, the user may be shown another set of related services as recommendations 212 in the module.

To generate recommendations of related services in the online marketplace, matching pairs of related services offered in the online marketplace are generated from data sources such as historical interactions with recommended services, historical RFPs, and/or previous recommendations of related services. Each matching pair may include two services that are identified to be related to one another. For example, a matching pair of related services may include a one-directional relationship between a first service and a second service (e.g., when requesting the first service leads to requesting the second service) or a bi-directional relationship between the first and second services (e.g., when requesting either service leads to requesting the other service).

Next, the matching pairs are ranked based on the data sources and popularities of the matching pairs. For example, the matching pairs may be ranked according to the following:
1. first-degree matching pairs from historical interactions, ordered by descending frequency or popularity
2. second-degree matching pairs from historical interactions, ordered by descending frequency or popularity
3. matching pairs from historical RFPs, ordered by descending lift
4. matching pairs from previous recommendations, ordered by descending frequency

When a user expresses interest in a service (e.g., by submitting an RFP for the service and/or having another type of positive interaction with the service), the ranking is used to identify a set of related services for the service and output the related services as recommendations to the user. For example, a subset of top-ranked matching pairs that contain the service may be identified, and other services in the matching pairs may be recommended as related services to the users.

By generating recommendations of related services based on data from multiple data sources, the disclosed embodiments may produce recommendations that are comprehensive and/or relevant to the users, thus increasing the value of the online network and/or online marketplace to the users, value provided to the online network and/or online marketplace by the members, and/or user engagement with the online network and/or online marketplace. In contrast, conventional techniques may generate recommendations from user-generated lists of related services, which involve manual, static user input that ignores real-time signals and/or user preferences in the online marketplace. Consequently, the disclosed embodiments may improve technologies related to use of online networks and/or online marketplaces through network-enabled devices and/or applications, as well as user engagement, user experiences, and interaction through the online networks, online marketplaces, network-enabled devices, and/or applications.

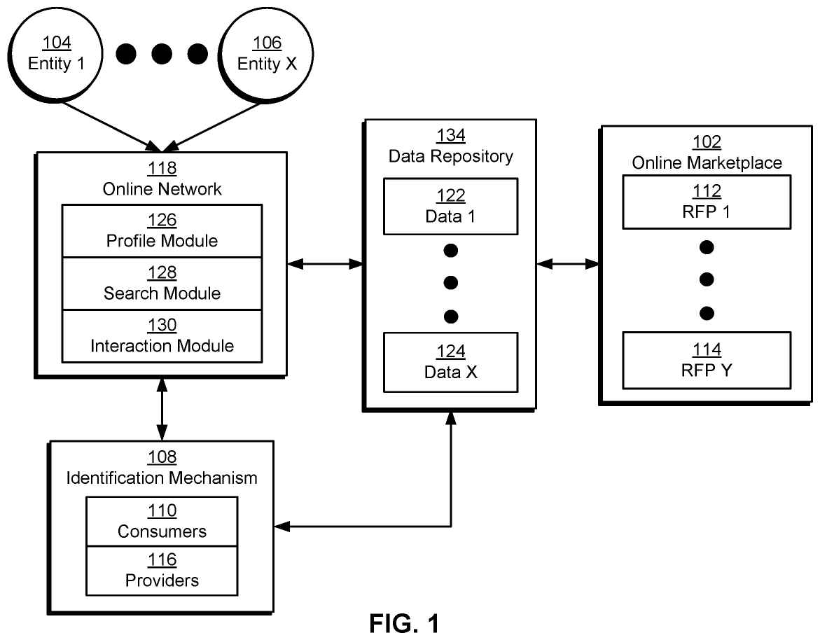

FIG. 1 shows a schematic of a system in accordance with the disclosed embodiments. In the system of FIG. 1, an online marketplace 102 may be associated with a user community such as an online network 118. In one or more embodiments, online network 118 includes an online professional network that is used by a set of entities (e.g., entity 1 104, entity x 106) to interact with one another in a professional and/or business context.

The entities may include users that use online network 118 to establish and maintain professional connections, list work and community experience, endorse and/or recommend one another, search and apply for jobs, and/or perform other actions. The entities may also include companies, employers, and/or recruiters that use online network 118 to list jobs, search for potential candidates, provide business-related updates to users, advertise, and/or take other action.

Online network 118 includes a profile module 126 that allows the entities to create and edit profiles containing information related to the entities' professional and/or industry backgrounds, experiences, summaries, job titles, projects, skills, and so on. Profile module 126 may also allow the entities to view the profiles of other entities in online network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online network 118 also includes a search module 128 that allows the entities to search online network 118 for people, companies, jobs, and/or other job- or business-related information. For example, the entities may input one or more keywords into a search bar to find profiles, job postings, job candidates, articles, and/or other information that includes and/or otherwise matches the keyword(s). The entities may additionally use an “Advanced Search” feature in online network 118 to search for profiles, jobs, and/or information by categories such as first name, last name, title, company, school, location, interests, relationship, skills, industry, groups, salary, experience level, etc.

Online network 118 further includes an interaction module 130 that allows the entities to interact with one another on online network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online network 118 may include other components and/or modules. For example, online network 118 may include a homepage, landing page, and/or content feed that provides the latest posts, articles, and/or updates from the entities' connections and/or groups to the entities. Similarly, online network 118 may include features or mechanisms for recommending connections, job postings, articles, and/or groups to the entities.

In one or more embodiments, data (e.g., data 1 122, data x 124) related to the entities' profiles and activities on online network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online network 118 may be tracked and stored in a database, data warehouse, cloud storage, and/or other data-storage mechanism providing data repository 134.

In turn, member profiles and/or activity with online network 118 may be used to improve interaction between consumers 110 and providers 116 and/or use of online marketplace 102 by consumers 110 and providers 116. Online marketplace 102 allows consumers 110 to generate RFPs (e.g., RFP 1 112, RFP y 114) for products or services by inputting requirements associated with the RFPs into a user interface, form, email, and/or other mechanism for digital communication or interaction. Online marketplace 102 may use the inputted requirements to select providers 116 that meet the requirements and transmit the RFPs to the selected providers 116. The selected providers 116 may respond to the RFPs with proposals, and consumers 110 that generated the RFPs may use the proposals to select providers 116 for the corresponding products or services.

As shown in FIG. 1, consumers 110 and/or providers 116 may be identified by an identification mechanism 108 using data from data repository 134 and/or online network 118. First, identification mechanism 108 may identify consumers 110 based on browsing, searching, and/or viewing activities of entities with online network 118. For example, identification mechanism 108 may determine that a member of online network 118 is interested in career services offered through online marketplace 102 based on the member's job-seeking activity (e.g., job searches, job applications, etc.) and/or profile-editing activity (e.g., profile edits, soliciting recommendations or endorsements, etc.) with online network 118. In another example, identification mechanism 108 may identify a member of online network 108 as a potential consumer when the member searches online marketplace 102 for products and/or services and/or submits an RFP through online marketplace 102.

Second, identification mechanism 108 may identify providers 116 as members of online network 118 who are highly skilled at services offered through online marketplace 102 and/or who have registered with online marketplace 102 as providers 116 of the services. For example, identification mechanism 108 may use endorsements, recommendations, and/or other social validation of skills listed in the member's profiles with online network 118 to identify members who are likely to be highly capable of providing services listed in online marketplace 102. In another example, identification mechanism 108 may identify a member of online network 118 as a provider in online marketplace 102 when the member views a page in online marketplace 102 for a service that strongly matches the member's skills and/or registers as a provider with online marketplace 102.

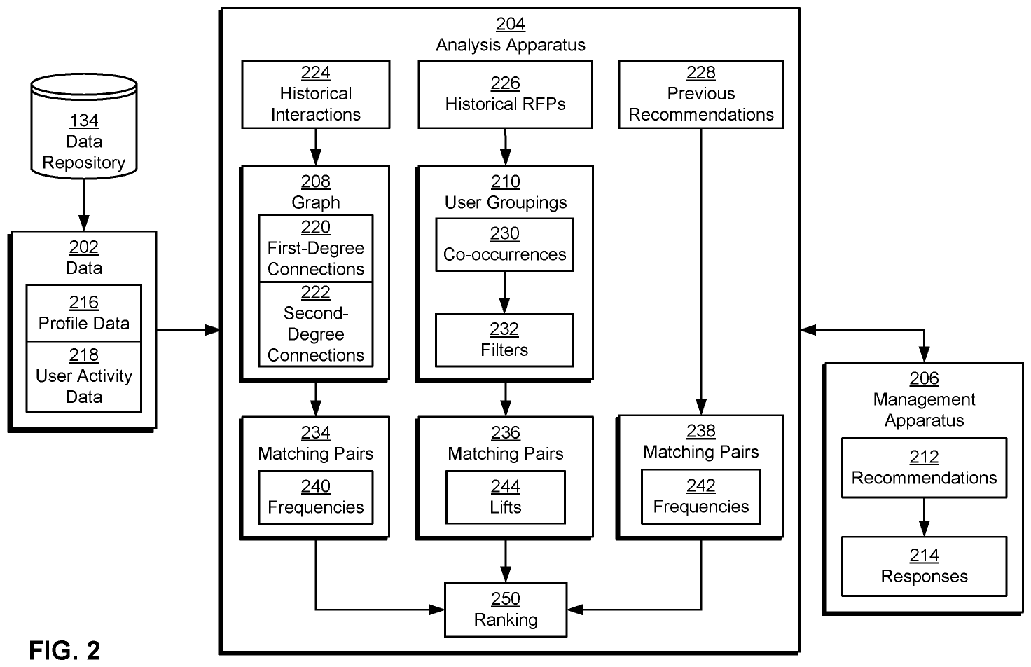

In one or more embodiments, online marketplace 102 uses data from online network 118 and/or data repository 134 to recommend services to members of online network 118 and/or users of online marketplace 102. As shown in FIG. 2, a system for recommending related services in an online marketplace (e.g., online marketplace 102 of FIG. 1) includes an analysis apparatus 204 and a management apparatus 206. Each of these components is described in further detail below.

As shown in FIG. 2, the system utilizes data 202 from data repository 134, which includes profile data 216 for members of an online network (e.g., online network 118 of FIG. 1) or other community of users, as well as user activity data 218 that tracks the members' activity within and/or outside the community. Profile data 216 may include data associated with member profiles in the community. For example, profile data 216 for an online professional network may include a set of attributes for each user, such as demographic (e.g., gender, age range, nationality, location, language), professional (e.g., job title, professional summary, professional headline, employer, industry, experience, skills, seniority level, professional endorsements), social (e.g., organizations to which the user belongs, geographic area of residence), and/or educational (e.g., degree, university attended, certifications, licenses) attributes. Profile data 216 may also include a set of groups to which the user belongs, the user's contacts and/or connections, awards or honors earned by the user, licenses or certifications attained by the user, patents or publications associated with the user, and/or other data related to the user's interaction with the community.

Attributes of the members may be matched to a number of member segments, with each member segment containing a group of members that share one or more common attributes. For example, member segments in the community may be defined to include members with the same industry, title, location, and/or language.

Connection information in profile data 216 may additionally be combined into a graph (e.g., graph 208), with nodes in the graph representing entities (e.g., users, schools, companies, locations, etc.) in the community. Edges between the nodes in the graph may represent relationships between the corresponding entities, such as connections between pairs of members, education of members at schools, employment of members at companies, following of a member or company by another member, business relationships and/or partnerships between organizations, and/or residence of members at locations.

User activity data 218 may include records of user interactions with one another and/or content associated with the community. For example, user activity data 218 may be used to track impressions, clicks, likes, dislikes, shares, hides, comments, posts, updates, conversions, and/or other user interaction with content in the community. User activity data 218 may also, or instead, track other types of community activity, including connections, messages, job applications, job searches, recruiter searches for candidates, interaction between candidates 116 and recruiters, and/or interaction with groups or events. User activity data 218 may further include social validations of skills, seniorities, job titles, and/or other profile attributes, such as endorsements, recommendations, ratings, reviews, collaborations, discussions, articles, posts, comments, shares, and/or other member-to-member interactions that are relevant to the profile attributes. User activity data 218 may additionally include schedules, calendars, and/or upcoming availabilities of the users, which may be used to schedule meetings, interviews, and/or events for the users.

User activity data 218 may further track activities related to the online marketplace. The activities may include, but are not limited to, browsing or searching the online marketplace for providers, services, products, and/or projects; submitting, receiving, responding to, and/or accepting RFPs and proposals; viewing profiles of providers in the online marketplace; exchanging messages with providers and/or consumers; sending and/or receiving connection invitations with providers and/or consumers; and/or rating or reviewing providers and/or consumers. Like profile data 216, user activity data 218 may be used to create a graph (e.g., graph 208), with nodes in the graph representing social network members and/or content and edges between pairs of nodes indicating actions taken by members, such as creating or sharing articles or posts, sending messages, sending or accepting connection requests, browsing services in the online marketplace, sending and accepting RFPs, sending and accepting proposals, joining groups, and/or following other entities.

Profile data 216, user activity data 218, and/or other data 202 in data repository 134 may be standardized before the data is used by components of the system. For example, skills in profile data 216 may be organized into a hierarchical taxonomy that is stored in data repository 134 and/or another repository. The taxonomy may model relationships between skills (e.g., “Java programming” is related to or a subset of “software engineering”) and/or standardize identical or highly related skills (e.g., “Java programming,” “Java development,” “Android development,” and “Java programming language” are standardized to “Java”).

In another example, locations in data repository 134 may include cities, metropolitan areas, states, countries, continents, and/or other standardized geographical regions. In a third example, data repository 134 includes standardized company names for a set of known and/or verified companies associated with the members and/or jobs. In a fourth example, data repository 134 includes standardized titles, seniorities, and/or industries for various jobs, members, and/or companies in the online network. In a fifth example, data repository 134 includes standardized time periods (e.g., daily, weekly, monthly, quarterly, yearly, etc.) that can be used to retrieve other data that is represented by the time periods (e.g., starting a job in a given month or year, graduating from university within a five-year span, job listings posted within a two-week period, etc.). In a sixth example, data repository 134 includes standardized types and/or groupings of services and/or products offered by or through the online network and/or online marketplace.

Analysis apparatus 204 uses profile data 216, user activity data 218, and/or other data 202 in data repository 134 to generate recommendations 212 of services that relate to other services in which a member has expressed interest. In turn, management apparatus 206 may display recommendations 212 to the member to improve the value of the online marketplace to the member and/or usage of the online marketplace by the member.

For example, the member may fill out an RFP for a design service, writing service, accounting service, marketing service, legal service, real estate service, software service, information technology (IT) service, business service, financial service, insurance service, photography service, career service, coaching service, and/or other type of service listed in the online marketplace. After the RFP is submitted, a page confirming successful submission of the RFP may be shown to the member. The page may also include a “related services you may be interested in” module that displays recommendations 212 of services that are related to the service requested by the member in the RFP. The member may click on a recommended service to begin a new RFP for the service; if the member successfully submits the new RFP, the member may be shown another set of related services as recommendations 212 in the module.

More specifically, analysis apparatus 204 generates recommendations 212 from sets of data 202 associated with multiple data sources. The data sources include historical interactions 224 between members and service recommendations 212, historical RFPs 226 submitted by the members, and previous recommendations 228 of services by the system and/or a related system. Analysis apparatus 204 analyzes data from the data sources to identify matching pairs 234-238 of related services offered in the online marketplace. Each matching pair includes two services that are identified to be related to one another. For example, a matching pair of related services may include a one-directional relationship between a first service and a second service (e.g., when requesting the first service leads to requesting the second service) or a bi-directional relationship between the first and second services (e.g., when requesting either service leads to requesting the other service).

First, analysis apparatus 204 uses a graph 208 of historical interactions 224 to obtain a first set of matching pairs 234 of related services. Graph 208 may be populated and/or updated with nodes and edges based on tracking events for historical interactions 224 from data repository 134 and/or another data store. A tracking event may be generated when a member clicks on a recommended service (e.g., in a “services you may be interested in” module) after the member completes an RFP for an “origin” service and/or otherwise interacts with the origin service. The tracking event may include a tracking identifier (ID) that is maintained during the member's session with the online marketplace and/or online network.

The tracking event and/or tracking ID may be used to identify a series of related services that start with the origin service and end when the member's session terminates. The related services may include recommendations 212 of services that the user clicks and/or other services requested by the user (e.g., through submission of RFPs for the services). The origin service and related services may then be represented as nodes in graph 208. Directed or undirected edges between the nodes may represent the member's direct interactions with service recommendations 212 (e.g., clicking on a service recommendation after completing an RFP for a service). The edges may also, or instead, indicate indirect interactions that include positive interactions with services after the tracking event and/or ID are created (e.g., navigating away from an RFP for a recommended service but completing a new RFP for a different service in the same session).

For example, a tracking event may be generated after the member completes an RFP for service “A” and clicks on a recommendation of service “B” as a related service to “A.” The member may subsequently complete an RFP for service “B” and click on a recommendation of service “C” as a related service to “B.” Thus, graph 208 may include nodes representing services “A,” “B,” and “C” and edges connecting “A” to “B” and “B” to “C” to indicate the series of direct interactions with service recommendations 212 based off of the initial completion of the RFP for service “A.”

Alternatively, the member (or a different member) may click on the recommendation of service “B” after completing the RFP for service “A” and navigate away from the RFP for service “B” before submitting the RFP. Instead, the member may browse or search other services in the online marketplace and submit a different RFP for service “D” during the same user session. As a result, graph 208 may have an edge between nodes representing “B” and “D” that indicates an indirect interaction with service “D” after the member completes the RFP for “A” and clicks on the recommendation of “B.”

In turn, analysis apparatus 204 generates matching pairs 234 from first-degree connections 220 and second-degree connections 222 in graph 208. First-degree connections 220 may include pairs of nodes that are directly connected to one another in graph 208, while second-degree connections 222 may include pairs of nodes that are indirectly connected to one another via one or more intermediate nodes. Continuing with the above example, analysis apparatus 204 may use nodes and edges between services “A,” “B,” “C, and “D” to identify “first-degree” matching pairs 234 of “A” and “B,” “B” and “C,” and “B” and “D” and “second-degree” matching pairs 234 of “A” and “C,” “A” and “D,” and optionally “C” and “D” (if directionality in edges of graph 208 is not considered in forming matching pairs 234). Analysis apparatus 204 may also create additional matching pairs 234 in the reverse order (e.g., “B” and “A,” “C” and “B,” “D” and “B,” “C” and “A,” “D” and “A,” and/or “D” and “C”) if the services within the matching pairs have directed and/or ordered relationships. Alternatively, analysis apparatus 204 may implicitly create each matching pair to include an unordered set of two services (e.g., services “A” and “B” independent of which service led to the other service in historical interactions 224).

Analysis apparatus 204 may also calculate a set of frequencies 240 associated with matching pairs 234. For example, analysis apparatus 204 may determine the frequency of each ordered or unordered matching pair created from a first-degree connection in graph 208 as the number or proportion of occurrences of the matching pair in historical interactions 224 and/or user activity data 218. Analysis apparatus 204 may then determine the frequency of each ordered or unordered matching pair created from a second-degree connection in graph 208 as the sum, product, and/or another combination of the frequencies of the two first-degree matching pairs from which the matching pair was created.

Next, analysis apparatus 204 uses user groupings 210 of historical RFPs 226 to produce a second set of matching pairs 236 of related services. User groupings 210 may include groupings of historical RFPs 226 by users and/or time spans. For example, each user grouping may include a set of RFPs submitted by the same user during the same user session and/or within a pre-specified period (e.g., a number of hours, a day, a week, etc.).

As a result, analysis apparatus 204 may use a market basket analysis technique to discover matching pairs 236 from co-occurrences 230 of services within user groupings 210. For example, analysis apparatus 204 may identify co-occurrences 230 as pairs, sets, and/or sequences of services that are found within user groupings 210 and/or otherwise requested together by users, based on historical RFPs 226 submitted by the users. In turn, matching pairs 236 may include all possible pairs of services within co-occurrences 230 in each user grouping.

Analysis apparatus 204 also applies a set of filters 232 to metrics associated with co-occurrences 230 to produce matching pairs 236. For example, analysis apparatus 204 may calculate a support and a confidence for each pair of co-occurring services identified from historical RFPs 226 and user groupings 210. The support may be calculated as the proportion of user groupings 210 in which the pair of co-occurring services are found, and the confidence may be calculated as the likelihood of one service in the pair appearing in a given grouping, given the appearance of the other service in the pair. In other words, the support may be obtained by dividing the number of user groupings 210 containing the pair by the total number of user groupings 210 obtained from a given set of historical RFPs 226. Similarly, the confidence in a service “A” given a request for a service “B” may be obtained by dividing the support of “A” and “B” by the support for only “A.”

In turn, filters 232 may include a minimum support (e.g., 0.001) and a minimum confidence (e.g., 0.01) for each pair of co-occurring services, so that a pair of co-occurring services is added to matching pairs 236 if the minimum support and confidence are met. The minimum support and minimum confidence may optionally be adjusted based on the types of services in co-occurrences 230, values of support and confidence calculated from co-occurrences 230, and/or other factors.

Analysis apparatus 204 further calculates a set of lifts 244 for matching pairs 236 that pass filters 232. Each lift may be calculated as the likelihood of requesting a first service in a matching pair when the second service in the matching pair has been requested, controlling for the popularity of the first service. For example, the lift of a matching pair containing services “A” and “B” may be calculated as the support of “A” and “B” divided by the product of the support of “A” and the support of “B” (i.e., support(A, B)/(support(A)*support(B)).

Finally, analysis apparatus 204 obtains a third set of matching pairs 238 from previous recommendations 228 of services to users of the online marketplace. For example, analysis apparatus 204 may obtain matching pairs 238 from a static and/or user-generated list of related services and/or a hierarchical taxonomy of the services in data repository 134. As with matching pairs 234, analysis apparatus 204 also calculates frequencies 242 for matching pairs 238 as the number or proportion of occurrences of each matching pair in user activity data 218 from data repository 134.

Analysis apparatus 204 then generates a ranking 250 of matching pairs 234-238 and uses ranking 250 to identify recommendations 212 of related services for a given service. As shown in FIG. 2, ranking 250 may be based on data sources associated with matching pairs 234-238 and/or frequencies 240-242 and lifts 244 calculated for matching pairs 234-238.

For example, ranking 250 may be generated as a broad ranking of matching pairs 234 generated from first-degree connections 220 associated with historical interactions 224, followed by matching pairs 234 generated from second-degree connections 220 associated with historical interactions, followed by matching pairs 236 from historical RFPs 226, followed by matching pairs 238 from previous recommendations 228. Within each subset of matching pairs 234 generated from first-degree connections 220 and second-degree connections 222 in graph 208, individual matching pairs 234 may be ordered by descending value of frequencies 240, so that matching pairs 234 that are most popular and/or frequently encountered are at the top of the subset.

Within the second-highest-ranked set of matching pairs 236 from historical RFPs 226, individual matching pairs 236 may be ranked by descending value of lifts 244, so that matching pairs 236 with the highest lifts 244 appear at the top of the set. Within the third-highest-ranked set of matching pairs 238 from previous recommendations 228, individual matching pairs 238 may be ranked by descending value of frequencies 242, so that matching pairs 238 with the highest frequencies 242 appear at the top of the set. In other words, ranking 250 may have the following representation:
5. first-degree matching pairs from historical interactions, ordered by descending frequency
6. second-degree matching pairs from historical interactions, ordered by descending frequency
7. matching pairs from historical RFPs, ordered by descending lift
8. matching pairs from previous recommendations, ordered by descending frequency

Management apparatus 206 then generates and/or outputs recommendations 212 based on ranking 250. For example, management apparatus 206 may identify a service requested in an RFP that was recently submitted by a user. Management apparatus 206 may identify a number of matching pairs containing the service in ranking 250 (e.g., ordered matching pairs in which the service appears first or unordered matching pairs in which the service appears either first or second) and select a subset of the top-ranked matching pairs as recommendations 212 of related services. Management apparatus 206 may also, or instead, generate one or more recommendations 212 from matching pairs associated with a specific data source (e.g., historical interactions 224, historical RFPs 226, previous recommendations 228, etc.). Management apparatus 206 may also, or instead, generate one or more recommendations 212 from a random selection of one or more matching pairs containing the service from ranking 250 to expose users of the online marketplace to new and/or different recommendations 212.

Management apparatus 206 may then include recommendations 212 in a “related services you may be interested in” module of the online marketplace. Management apparatus 206 may also, or instead, output recommendations 212 in an email, message, notification, and/or other communication; a content feed, service home page, and/or other part of the online network; and/or advertisements within or outside the online marketplace and/or online network.

Management apparatus 206 may also track responses 214 to recommendations 212. For example, management apparatus 206 may categorize clicks, RFPs, and/or other subsequent actions that follow through on recommendations 212 as positive responses and a lack of subsequent action related to recommendations 212 as negative responses. Each response may be stored in data repository 134 with an identifier of the corresponding user, an identifier of the recommendation to which the response was made, a timestamp of the response, and/or other data.

In turn, analysis apparatus 204 and/or another component of the system may use the response to update matching pairs 234-238 and/or ranking 250. For example, the component may use a number of positive responses to a recommendation for a headshot photography service following RFPs submitted for resume writing service to increase the frequency of a matching pair containing both services, the position of the matching pair in ranking 250, and/or use of the matching pair in generating recommendations 212. Conversely, the component may reduce the frequency and/or position of a matching pair in ranking 250 when a recommendation of either service in the matching pair following a positive interaction with the other service in the matching pair produces little to no positive response from the users.

By generating and updating recommendations 212 of related services based on data 202 from multiple data sources, the system of FIG. 2 may improve the quality, comprehensiveness, and relevance of recommendations 212 over recommendations that are produced from fewer data sets and/or user-generated lists of related services. In turn, the system may increase the value of the online network and/or online marketplace to the users, value provided to the online network and/or online marketplace by the members, and/or user engagement with the online network and/or online marketplace. Consequently, the system may improve technologies related to use of online networks and/or online marketplaces through network-enabled devices and/or applications, as well as user engagement, user experiences, and interaction through the online networks, online marketplaces, network-enabled devices, and/or applications.

Those skilled in the art will appreciate that the system of FIG. 2 may be implemented in a variety of ways. First, analysis apparatus 204, management apparatus 206, and/or data repository 134 may be provided by a single physical machine, multiple computer systems, one or more virtual machines, a grid, a cluster, one or more databases, one or more filesystems, and/or a cloud computing system. Analysis apparatus 204 and management apparatus 206 may additionally be implemented together and/or separately by one or more hardware and/or software components and/or layers. Data sources, matching pairs 234-238, ranking 250, and/or other data used by analysis apparatus 204 and management apparatus 206 may be generated and/or updated on an offline, online, and/or on-demand basis to accommodate requirements or limitations associated with the processing, performance, or scalability of the system and/or the availability of the data in data repository 134 or another data store.

Second, matching pairs 234-238 and ranking 250 may be produced in a number of ways. For example, additional matching pairs of services may be determined using a machine learning model that predicts the likelihood of a given service being requested when another service has already been requested. In turn, the pairs of services may be ranked by the corresponding likelihoods, and recommendations 212 may be selected from the ranked pairs. In another example, matching pairs in ranking 250 may be ordered according to other statistics and/or metrics, in lieu of or in addition to frequencies 240-242 and/or lifts 244.

Third, the functionality of the system may be adapted to generate other types of recommendations 212. For example, the system may be used to generate recommendations of goods, products, and/or other items listed in the online marketplace based on previous browsing, searching, and/or requesting behavior by users of the online marketplace.

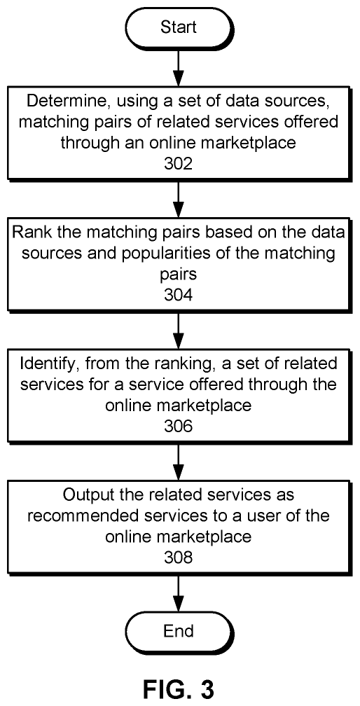

FIG. 3 shows a flowchart illustrating a process of improving use of an online marketplace in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, matching pairs of related services offered through the online marketplace are determined using a set of data sources (operation 302). The related services may include, but are not limited to, a design service, writing service, accounting service, marketing service, legal service, real estate service, software service, information technology (IT) service, business service, financial service, insurance service, photography service, career service, and/or coaching service. The data sources may include historical interactions with recommended services, historical RFPs submitted to the online marketplace, and/or previously recommended services in the online marketplace. As a result, a different subset of matching pairs may be produced from each data source.

To generate a subset of matching pairs from the historical interactions, a graph of the historical interactions may be produced. The graph may be created and/or updated based on tracking events for the historical interactions. The tracking events may track positive interactions with origin services that lead directly to positive interactions with recommended services. For example, a connection between two nodes in the graph may be added when a user submits an RFP for a first service, clicks on a recommendation of a second service as a related service of the first service, and submits an additional RFP for the second service in the same user session. The tracking events may also, or instead, track positive interactions with origin services that indirectly lead to positive interactions with non-recommended services. For example, a connection between two nodes in the graph may be added when a user submits an RFP for a first service, clicks on a recommendation of a second service as a related service of the first service, navigates away from an RFP for the second service before submitting the RFP, and instead submits an RFP for a third service during the same user session.

In turn, matching pairs may be generated from both first- and second-degree connections in the graph. For example, the graph may include an edge between a first node and a second node and another edge between the second node and a third node. As a result, matching pairs may be generated from services represented by the first and second nodes, second and third nodes, and first and third nodes.

To generate matching pairs from the historical RFPs, the historical RFPs may be grouped by user and/or time span. For example, the historical RFPs may be divided into groups of RFPs, with each group of RFPs representing a specific user and/or a time period in which the RFPs were received (e.g., a user session, an hour, a day, a week, etc.). Next, matching pairs of services may be produced as all possible pairs of services within each group of RFPs. The matching pairs may then be filtered by a minimum support and/or a minimum confidence.

Finally, the previously recommended services may be obtained as a static and/or user-generated list of related services. In turn, matching pairs may be obtained from individual items or rows in the list (e.g., an item containing an origin service and a recommended service and/or an item containing two related services).

Next, the matching pairs are ranked based on the data sources and popularities of the matching pairs (operation 304). Subsets of the matching pairs may first be ranked according to the data sources used to generate the matching pairs, followed by ranking of individual matching pairs in each subset by the corresponding popularities (e.g., frequencies, lifts, other metrics, etc.). For example, the matching pairs may include a highest-ranked subset of matching pairs formed from historical interactions with recommended services, which include matching pairs formed from first-degree connections in the graph that are ordered by descending frequency and ranked above matching pairs formed from second-degree connections in the graph that are also ordered by descending frequency. The highest-ranked subset may be followed by a second-highest-ranked subset of matching pairs formed from historical RFPs that are ordered by descending lift, followed by a third-highest-ranked subset of matching pairs from previously recommended services that are ordered by descending frequency.

A set of related services for a service offered through the online marketplace is then identified from the ranking (operation 306) and outputted as recommended services to a user of the online marketplace (operation 308). For example, the service may be identified when a user submits an RFP for the service and/or has another type of positive interaction with the service. In turn, the ranking may be searched for a subset of top-ranked matching pairs containing the service (e.g., the top 5-10 matching pairs containing the service), and the related services may be obtained as the other services in the matching pairs. The related services may then be recommended to the user in an “other services you may be interested in” module, notification, email, message, advertisement, post, and/or other type of communication.

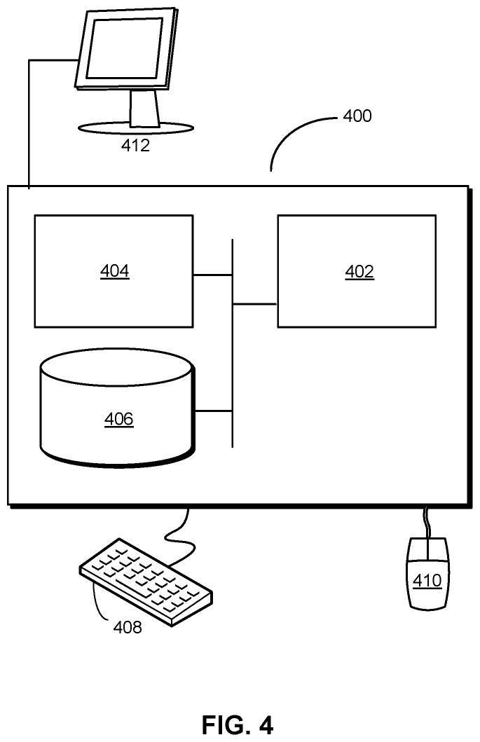

FIG. 4 shows a computer system 400 in accordance with the disclosed embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for recommending related services in an online system such as an online marketplace. The system includes an analysis apparatus and a management apparatus, one or more of which may alternatively be termed or implemented as a module, mechanism, or other type of system component. The analysis apparatus determines, from a set of data sources, matching pairs of related services offered through the online system. Next, the analysis apparatus ranks the matching pairs based on the set of data sources and popularities of the matching pairs. The management apparatus then identifies, based on the ranking, a set of related services for a service offered through the online system. Finally, the management apparatus outputs the set of related services as recommended services to a user of the online system.

In addition, one or more components of computer system 400 may be remotely located and connected to the other components over a network. Portions of the present embodiments (e.g., analysis apparatus, management apparatus, data repository, online network, online marketplace, etc.) may also be located on different nodes of a distributed system that implements the embodiments. For example, the present embodiments may be implemented using a cloud computing system that recommends related services to remote users of an online marketplace.

By configuring privacy controls settings as they desire, members of a social network, a professional network, or other user community that may use or interact with embodiments described herein can control or restrict the information that is collected from them, the information that is provided to them, their interactions with such information and with other members, and/or how such information is used Implementation of these embodiments is not intended to supersede or interfere with the members' privacy settings.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
determining, by one or more computer systems using a set of data sources, matching pairs of related services offered through an online system, wherein the set of data sources comprises historical interactions with recommended services and historical requests for proposal (RFPs);
ranking, by the one or more computer systems, the matching pairs based on the set of data sources and popularities of the matching pairs;
identifying, by the one or more computer systems based on the ranking, a set of related services for a service offered through the online system; and
outputting the set of related services as recommended services to a user of the online system.

2. The method of claim 1, wherein determining the matching pairs of related services using the historical interactions with recommended services comprises:
generating a subset of the matching pairs from a graph of the historical interactions with recommended services.

3. The method of claim 2, wherein generating the subset of the matching pairs from the graph of the historical interactions with recommended services comprises:
generating a first matching pair from a first-degree connection of a first node in the graph to a second node in the graph.

4. The method of claim 3, wherein generating the subset of the matching pairs from the graph of the historical interactions with recommended services further comprises:
generating a second matching pair from a second-degree connection of the first node to a third node in the graph.

5. The method of claim 2, wherein generating the subset of the matching pairs from the graph of the historical interactions with recommended services comprises:
adding nodes and edges to the graph based on tracking events for the historical interactions with recommended services.

6. The method of claim 5, wherein the tracking events comprise at least one of:
a first tracking event for a first positive interaction with a first origin service that leads to a second positive interaction with a recommended service; and
a second tracking event for a third positive interaction with a second origin service that leads to a fourth positive interaction with a non-recommended service.

7. The method of claim 1, wherein determining the matching pairs of related services using the historical RFPs comprises:
generating a subset of the matching pairs from co-occurrences of services requested in the historical RFPs.

8. The method of claim 7, wherein generating the subset of the matching pairs from the co-occurrences of services requested in the historical RFPs comprises:
determining the subset of the matching pairs from the co-occurrences of services within groupings of the historical RFPs by users of the online system; and
filtering the subset of the matching pairs by a minimum support and a minimum confidence.

9. The method of claim 1, wherein ranking the matching pairs based on the set of data sources and the popularities of the matching pairs comprises:
ranking the matching pairs by the set of data sources; and
ranking a subset of the matching pairs associated with a data source in the set of data sources by a subset of the popularities for the subset of the matching pairs.

10. The method of claim 9, wherein ranking the subset of the matching pairs associated with the data source by the subset of popularities for the subset of the matching pairs comprises:
ranking the subset of the matching pairs associated with the historical RFPs by lifts associated with the subset of matching pairs.

11. The method of claim 9, wherein ranking the subset of the matching pairs associated with the data source by the subset of popularities for the subset of the matching pairs comprises:
ranking the subset of the matching pairs associated with the historical interactions with recommended services by frequencies associated with the subset of matching pairs.

12. The method of claim 9, wherein ranking the matching pairs by the set of data sources comprises:
ranking the matching pairs by a first subset of the matching pairs formed from the historical interactions with recommended services, followed by a second subset of the matching pairs formed from the historical RFPs, followed by a third subset of the matching pairs from a set of previously recommended services.

13. The method of claim 1, wherein identifying, based on the ranking, the set of related services for a service offered through the online system comprises:
identifying the set of related services from a set of top-ranked matching pairs that comprise the service in the ranking.

14. The method of claim 1, wherein the service and the set of related services comprise at least one of:
a design service;
a writing service;
an accounting service;
a marketing service;
a legal service;
a real estate service;
a software service;
an information technology (IT) service;
a business service;
a financial service;
an insurance service;
a photography service;
a career service; and
a coaching service.

15. A system, comprising:
one or more processors; and
memory storing instructions that, when executed by the one or more processors, cause the system to:
determine, using a set of data sources, matching pairs of related services offered through an online system, wherein the set of data sources comprises historical interactions with recommended services and historical requests for proposal (RFPs);
rank the matching pairs based on the set of data sources and popularities of the matching pairs;
identify, based on the ranking, a set of related services for a service offered through the online system; and
output the set of related services as recommended services to a user of the online system.

16. The system of claim 15, wherein determining the matching pairs of related services using the historical interactions with recommended services comprises:
generating a subset of the matching pairs from a graph of the historical interactions with recommended services, wherein the graph is updated based on tracking events for the historical interactions with recommended services.

17. The system of claim 16, wherein generating the subset of the matching pairs from the graph of the historical interactions with recommended services comprises:
generating a first matching pair from a first-degree connection of a first node in the graph to a second node in the graph; and
generating a second matching pair from a second-degree connection of the first node to a third node in the graph.

18. The system of claim 15, wherein determining the matching pairs of related services using the historical RFPs comprises:
generating a subset of the matching pairs from co-occurrences of services requested in the historical RFPs; and
filtering the subset of the matching pairs by a minimum support and a minimum confidence.

19. The system of claim 15, wherein the online system comprises an online marketplace.

20. A non-transitory computer-readable storage medium storing instructions that when executed by a computer cause the computer to perform a method, the method comprising:
determining, using a set of data sources, matching pairs of related services offered through an online system, wherein the set of data sources comprises historical interactions with recommended services and historical requests for proposal (RFPs);
ranking the matching pairs based on the set of data sources and popularities of the matching pairs;
identifying, based on the ranking, a set of related services for a service offered through the online system; and
outputting the set of related services as recommended services to a user of the online system.
